(19) United States
(12) Patent Application Publication
(10) Pub. No.: US 2024/0355187 A1
(43) Pub. Date: Oct. 24, 2024

(54) EQUIPMENT USAGE MONITORING SYSTEM

(71) Applicant: EATON INTELLIGENT POWER LIMITED, Dublin (IE)

(72) Inventors: Padhraig RYAN, Keatingstown (IE); Sara HOLLAND, Southern Pines, NC (US); Daniel ZUCCHETTO, Dublin (IE)

(21) Appl. No.: 18/687,016

(22) PCT Filed: Nov. 4, 2021
(86) PCT No.: PCT/EP2021/080627

§ 371 Date: Feb. 27, 2024

(30) Foreign Application Priority Data
Sep. 3, 2021 (US) 63240753

(51) Int. Cl. G08B 21/02

(52) U.S. Cl. CPC G08B 21/02

(57) ABSTRACT

An equipment usage monitoring system for use with an equipment. The system comprises: a processor in communication with: the equipment; an equipment sensor operable to provide equipment data associated with the equipment; and an alert member operable to provide an alert to a user of the equipment. The processor is operable to: receive the equipment data from the equipment sensor; determine that the equipment data achieves a warning threshold; cause the alert member to provide an alert to the user in response to the warning threshold being met; determine that the equipment data achieves a stoppage threshold; and transmit a stoppage signal to the equipment in response to the stoppage threshold being met, the stoppage signal causing the equipment to turn off. Advantageously, there is provided a system which may monitor the use of the equipment via the equipment sensor, which provides equipment data related to the equipment. Whilst monitoring the use of the equipment, the system also advantageously mitigates a risk of injury by alerting the user in response to a warning threshold being met, and turning off the equipment in response to a stoppage threshold being met.

### CROSS-REFERENCE TO RELATED APPLICATIONS

This application is a national phase filing under 35 C.F.R. § 371 of and claims priority to PCT Patent Application No. PCT/EP2021/080627, filed on Nov. 4, 2021, which claims the priority benefit under 35 U.S.C. § 119 of U.S. Application No. 63/240,753, filed on, Sep. 3, 2021.

### TECHNICAL FIELD

The present disclosure relates to a system for monitoring the usage of equipment. In particular, the present disclosure relates to a system for monitoring the usage of a pneumatic drill.

### BACKGROUND

Workplace accidents and/or injuries can occur due to improper use of equipment such as a pneumatic drill. Improper use may result in serious injury such as maiming, or even death. Furthermore, accidents may occur due to overly long usage (i.e. failure to take rests at recommended intervals) of the equipment, or due to poor technique such as, for example, placing the drill against concrete at an improper angle. The risk of an accident occurring may also increase when a second person approaches the pneumatic drill in use and the user does not switch off the drill in accordance with recommended safety practices. The risk of vibration-induced injury may also be influenced by the frequency and amplitude of vibration of the pneumatic drill, and by a grip pressure of asserted on the pneumatic drill by the user.

The present disclosure has been devised to mitigate or overcome at least some of the above-mentioned problems or risks.

### SUMMARY OF THE DISCLOSURE

In accordance with a first aspect of the present disclosure, there is provided an equipment usage monitoring system for use with an equipment, the system comprising: a processor in communication with: the equipment; an equipment sensor operable to provide equipment data associated with the equipment; and an alert member operable to provide an alert to a user of the equipment; wherein the processor is operable to: receive the equipment data from the equipment sensor; determine that the equipment data achieves a warning threshold; cause the alert member to provide an alert to the user in response to the warning threshold being met; determine that the equipment data achieves a stoppage threshold; and transmit a stoppage signal to the equipment in response to the stoppage threshold being met, the stoppage signal causing the equipment to turn off.

The term “achieves a . . . threshold” will be understood by the skilled addressee as meaning that the equipment data is indicative of a magnitude or intensity that exceeds a threshold magnitude or intensity. The threshold may be a maximum threshold, such that if the magnitude or intensity associated with the equipment data is greater than or equal to the maximum threshold, the threshold is achieved. Alternatively, the threshold may be a minimum threshold, such that if the magnitude or intensity associated with the equipment data is less than or equal to the minimum threshold, the threshold is achieved.

The system finds particular use in relation to an equipment having an associated risk of harm or injury. For example, the equipment may be a pneumatic drill (jackhammer). The skilled person will appreciate that the equipment may be any device that is directly interacted with by a user. Further examples include a chainsaw; an angle grinder; a wood chipper; a hedge trimmer; and an automotive or aerospace machine.

The present disclosure advantageously provides a system which may monitor the use of the equipment via the equipment sensor, which provides equipment data related to the equipment. Whilst monitoring the use of the equipment, the system also advantageously mitigates a risk of injury by alerting the user in response to a warning threshold being met, and turning off the equipment in response to a stoppage threshold being met.

Preferably, the equipment sensor is one or more selected from the range of: a pressure sensor arranged to detect a pressure applied to the equipment; and a vibration sensor arranged to detect vibrational data of the equipment. In particular, the pressure sensor is preferably arranged to detect a pressure applied by the user to the equipment. For example, the pressure sensor may be a sleeve comprising a plurality of pressure sensors, to be placed on or in the equipment at a location suitable for measuring the pressure applied by the user. Alternatively, the pressure sensor may be a glove worn by the user, the glove comprising a plurality of pressure sensors configured to detect a pressure applied to the equipment via the glove. The skilled person will understand that the pressure sensor may be anything suitable for measuring a pressure applied by the user to the equipment. The vibration sensor is configured to detect vibrational data associated with the equipment. In particular, the vibration sensor is configured to detect a frequency and/or amplitude of vibration associated with the equipment. The vibration sensor may be, for example, a piezoelectric accelerometer placed on or within the equipment to quantify the frequency and/or amplitude of, for example, a pneumatic drill. The skilled person will appreciate that the vibration sensor may be any device suitable for measuring a frequency and/or amplitude of vibration of the equipment.

In some embodiments, the system further comprises a user sensor in communication with the processor, the user sensor configured to detect user data associated with the user. In particular, the user sensor is configured to detect data related to the user, rather than data directly related to the equipment. The user sensor may be placed on or proximate the user.

Preferably, the user sensor is a user vibration sensor arranged to detect vibrational data of the user. In particular, the vibrational data preferably represents an amplitude and/or frequency of vibration applied by the equipment, such as a pneumatic drill, to the user. For example, the vibration sensor may be a watch comprising a piezoelectric accelerometer, the watch being proximate the equipment in use. The user vibration sensor therefore advantageously provides a means for measuring an amplitude and/or frequency of vibration directly applied to the user's joints by the equipment. Accordingly, the biomechanical stress of vibration may be accounted for when determining the warning and/or stoppage thresholds.

In some embodiments, the warning threshold is an activity level warning threshold and the stoppage threshold is an activity level stoppage threshold. The term “activity level” will be understood by the skilled addressee as referring to an amount of use of the equipment for a particular usage session. Initially, the activity level may be set to a base level. The base level may arbitrarily be represented by a ‘0’. Usage of the equipment may lead to the activity level increasing. For example, the activity level may increase from a ‘0’ to a ‘1’ following a predetermined period of usage time. This predetermined period of usage time may be adjustable according to a variety of variables associated with the equipment and/or user. For example, the predetermined period of usage time may be shorter if the frequency and/or amplitude of the equipment measured by the equipment sensor is higher. Similarly, the predetermined period of usage time may be shorter if the frequency and/or amplitude of the equipment measured by the user vibration sensor is higher. Advantageously, a range of variables may be used to determine the activity level, and the thresholds may be dynamically adjusted depending on the intensity of use (wherein a higher amplitude and/or frequency of vibration corresponds to a higher intensity of use). The skilled person will appreciate that any variable corresponding to an intensity of use may be utilised in determining the activity level of the usage session.

The activity level may be reset following a predetermined period of time of the equipment being off. For example, the activity level may be reset to ‘0’ following the equipment being off for five minutes, wherein the equipment being off is indicative of the user taking a break from using the equipment. The predetermined period of time may be any length suitable for recovery of the user, and may be based on industry regulations and/or local recommendations.

In some embodiments, the activity level threshold is predetermined based on a correlation. This correlation may correspond to factors such as a period of time in which the equipment may be operated before the user meets a threshold, such as a pressure threshold, explained further below. Additional factors may include an age of the user; a gender of the user; a strength of the user; a grip pressure of the user; or other factors which may offer a statistical or causal relationship with the outcome of interest. The strength of the user may be determined based on data provided by a pressure sensor.

In some embodiments, the threshold is additionally one or more selected from the range of: a pressure threshold; and a temporal threshold. The pressure threshold may be a predetermined pressure threshold related to a grip pressure applied by the user to the equipment, as measured by the pressure sensor. The pressure threshold is preferably a minimum threshold such that once the grip pressure is less than the pressure warning threshold, the alert member is activated. Furthermore, if the grip pressure is less than the pressure stoppage threshold, the stoppage signal is transmitted to the equipment. Advantageously, if the user's grip becomes too weak to operate the device safely, the device switches off, thereby improving safety. Alternatively, there may be a preferred range of pressure values measured by the pressure sensor. If the pressure exceeds a maximum threshold, or is below a minimum threshold of the preferred range of pressure values, the alert member may be activated or the stoppage signal may be transmitted.

The temporal threshold preferably relates to an amount of time elapsed in the current usage session. In particular, once the warning threshold amount of time has elapsed, the alert member is activated and once the stoppage threshold amount of time has elapsed, the stoppage signal is transmitted to the equipment. The temporal threshold may be distinct from the activity level threshold as it may be a predetermined threshold that does not take into account data correlation.

In some embodiments, the equipment sensor is an angular position sensor. The term “angular position” will be understood by the skilled addressee as meaning an angular position or tilt of the equipment relative to an axis. The axis may be an axis perpendicular to a surface on which the equipment is being used. The position sensor may be a micro electro mechanical system (MEMS) accelerometer placed in or on the equipment. The MEMS accelerometer is preferably configured to provide an acceleration signal representative of an angular tilt of the equipment, such as the pneumatic drill, with respect to a surface on which the drill is being used. In particular, the MEMS accelerometer preferably provides a signal to the processor comprising a gravitational component and a vibrational component. The processor is preferably operable to apply a filtering algorithm that removes the vibrational component, such that the gravitational component is left. The gravitational component of the signal may be projected onto three orthogonal axes. When the MEMS accelerometer is static and in the absence of noise, the signal on the three axes is representative of an angle of the drill with respect to the Earth's gravitational field (i.e. an axis perpendicular to the surface on which the drill is being used). The skilled person will understand that the position sensor may be any device suitable for providing a signal indicative of a position or orientation of the equipment, such as a MEMS accelerometer with a gyroscope, or a tilt sensor.

In some embodiments, the warning threshold is an angular warning threshold and the stoppage threshold is an angular stoppage threshold. In particular, the angular thresholds relate to an angular position of the equipment, as measured by the angular position sensor. For example, in the pneumatic drill on a horizontal surface case, it is preferable that the drill is not operated perpendicular to the horizontal surface and should instead be tilted at a slight angle from the perpendicular axis. It is also preferable that the drill bit of the pneumatic drill is pointed away from the user, such that a handle of the drill is closer to the user than the drill bit is to the user. Accordingly, the angular thresholds may advantageously prevent the pneumatic drill from being used at an inappropriate angle. The pneumatic drill may be reset or readjusted following the angular thresholds being met.

In some embodiments, the equipment sensor is a proximity sensor. Preferably, the proximity sensor is a proximity sensing system configured to determine a distance between the equipment and a non-user's device. The proximity sensing system may utilise Bluetooth Low Energy, Wi-Fi, Ultrawide Band, Infrared, or another sensing modality. The skilled person will appreciate that the proximity sensing system may utilise any sensing modality suitable for facilitating communication between the proximity sensing system and the non-user's device, preferably with a range of at least 5 metres. The non-user's device may be a device associated with a non-user, the non-user being a person that is not the user of the equipment. The non-user's device may be a smartphone, a sensor-enabled identification badge, a helmet, or other personal protective equipment. The skilled person will appreciate that the non-user's device may be any device suitable for providing a means for communicating a proximity of the non-user to the equipment.

In some embodiments, the warning threshold is a proximity warning threshold and the stoppage threshold is a proximity stoppage threshold. Equipment such as a pneumatic drill should not be used in close proximity to other people (i.e. non-users of the equipment). There is a risk that the drill slips from its users' hands, which may subsequently lead to the injury of another person. The proximity threshold advantageously provides a system which detects the proximity of a non-user and alerts the user to such a proximity, and further causes the equipment to turn off if the non-user meets or achieves the proximity stoppage threshold.

In some embodiments, the processor stores, on a data store, an instance of the warning threshold and/or the stoppage threshold being met. These stored instances may be used to further refine thresholds applied to future usage sessions.

In accordance with a second aspect of the present disclosure, there is provided an equipment usage monitoring method for use with an equipment, the method comprising: receiving, at a processor from an equipment sensor, equipment data; determining, by the processor, that the equipment data achieves a warning threshold; causing, by the processor, an alert member to provide an alert to a user of the equipment, in response to the warning threshold being met; determining, by the processor, that the equipment data achieves a stoppage threshold; and transmitting, by the processor, a stoppage signal to the equipment in response to the stoppage threshold being met, the stoppage signal causing the equipment to turn off.

In some embodiments, the equipment sensor is one or more selected from the range of: a pressure sensor arranged to detect a pressure applied to the equipment; and a vibration sensor arranged to detect vibrational data of the equipment; and wherein the threshold is one or more selected from the range of: an activity threshold; a pressure threshold; and a temporal threshold.

In some embodiments, the equipment sensor is an angular position sensor, the warning threshold is an angular warning threshold, and the stoppage threshold is an angular stoppage threshold.

In some embodiments, the equipment sensor is a proximity sensor, the warning threshold is a proximity warning threshold, and the stoppage threshold is a proximity stoppage threshold.

### BRIEF DESCRIPTION OF THE DRAWINGS

One or more embodiments of the disclosure will now be described, by way of example only, with reference to the accompanying drawings, in which:

FIG. 1 is an equipment usage monitoring system according to a first aspect of the disclosure;

FIG. 2 is a representation of a flow diagram of a method for monitoring and mitigating user fatigue of a pneumatic drill;

FIG. 3 is a representation of a flow diagram of a method for monitoring and mitigating positioning of the pneumatic drill; and

FIG. 4 is a representation of a flow diagram of a method for monitoring and mitigating proximity of the pneumatic drill.

### DETAILED DESCRIPTION

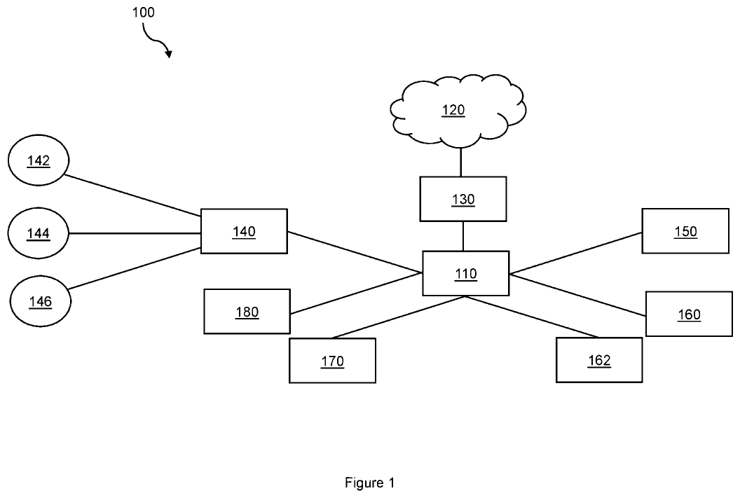

FIG. 1 is a schematic view of an equipment usage monitoring system 100 according to a first aspect of the present disclosure. The system includes a processor 110 that is in communication with a cloud-based server 120 via a smart device 130. The processor 110 may be physically or wirelessly connected to the smart device 130 such as a smart phone or a smart watch. For example, the processor 110 and smart device 130 may communicate wirelessly via Wi-Fi or Bluetooth. The system 100 is also in communication with an equipment (not shown), such as a pneumatic drill.

The system 100 also includes an array of pressure sensors 140, shown schematically by sensor elements 142, 144, 146. Although only three sensor elements 142, 144, 146 are shown, any number of sensor elements may be provided. For example, 368 sensor elements may be provided in a grid pattern. The array of pressure sensors 140 is configured to be arranged on an equipment to be gripped by a user, such as a pneumatic drill. In this case, the array of pressure sensors 140 may be on, under or embedded in the grip of the pneumatic drill or any other connected location. Alternatively, the pressure sensors 140 may be comprised in gloves worn by the user. Each sensor element 142, 144, 146 is operable to provide pressure data to the processor 110. Each sensor element 142, 144 146 may also be operable to provide an array position indicative of a position of each sensor element 142, 144, 146 on the sensor array 140.

Furthermore, the system 100 also includes an alert device 150. The alert device 150 may be a visual alert device 150 configured to provide a visual alert to the user. For example, the visual alert device 150 may be safety goggles having a screen configured to deploy a warning. The warning may depend on a risk level, wherein a green warning indicates a low risk of danger, an amber warning indicates a medium risk of danger, and a red warning indicates a high risk of danger. Additionally or alternatively, the alert device 150 may be an audible alert device 150 configured to provide an audible alert to the user. Other types of feedback device 150 are envisaged such as a haptic feedback device.

In addition, the system 100 includes a first vibrational sensor 160. In the present example, the first vibrational sensor 160 is a piezoelectric accelerometer operable to provide frequency and/or amplitude data to the processor 110, the frequency and amplitude being related to a vibration of the equipment. Other types of first vibrational sensor 160 are envisaged such as an accelerometer. The first vibrational sensor 160 is configured to be arranged on the equipment. In this case, the first vibrational sensor 160 may be on, under or embedded in the grip of the pneumatic drill or any other connected location.

Additionally or alternatively, the system includes a second vibrational sensor 162. In the present example, the second vibrational sensor 162 is arranged to be placed on the user. In particular, the second vibrational sensor 162 is a watch 162 located adjacent the equipment when in use, the watch being operable to detect vibrational data indicative of a level of vibration transmitted from the equipment to the user's body. In this case, the watch 162 may be located on a wrist of the user, adjacent the hand in which the pneumatic drill is held by the user.

The system 100 also comprises a proximity sensor 170. In the present example, the proximity sensor 170 is a wireless sensing system 170 configured to detect proximity data indicative of a distance between the equipment and a non-user's device. The wireless sensing system 170 may utilise Bluetooth Low Energy, Wi-Fi, Ultrawide Band, Infrared, or another sensing modality. The skilled person will appreciate that the wireless sensing system 170 may utilise any sensing modality suitable for facilitating communication between the wireless sensing system 170 and the non-user's device, preferably with a range of at least 5 metres. The non-user's device is a device associated with a non-user, the non-user being a person that is not the user of the equipment. The non-user's device may be a smartphone, a sensor-enabled identification badge, a helmet, or other personal protective equipment. The skilled person will appreciate that the non-user's device may be any device suitable for providing a means for communicating a proximity of the non-user to the equipment.

The system 100 also comprises a position sensor 180. The position sensor 180 may be integrated with the first vibrational sensor 160. In the present example, the position sensor 180 is a micro electro mechanical system (MEMS) accelerometer 180 placed in or on the equipment. The MEMS accelerometer 180 is configured to provide an acceleration signal representative of an angular tilt of the equipment, such as the pneumatic drill, with respect to a surface on which the drill is being used. In particular, the MEMS accelerometer 180 provides a signal comprising a gravitational component and a vibrational component. The processor 110 is operable to apply a filtering algorithm that removes the vibrational component, such that the gravitational component is left.

The gravitational component of the signal is projected onto three orthogonal axes. When the MEMS accelerometer is static and in the absence of noise, the signal on the three axes is representative of an angle of the drill with respect to the Earth's gravitational field (i.e. an axis perpendicular to the surface on which the drill is being used). Alternatively, the position sensor 180 may be any device suitable for providing a signal indicative of a position of the equipment, such as a MEMS accelerometer and a gyroscope, or a tilt sensor.

The skilled person will understand that in some embodiments, the system 100 comprises one or more of: the array of pressure sensors 140, the alert device 150, the first vibrational sensor 160, the second vibrational sensor 162, the proximity sensor 170, and the position sensor 180. Accordingly, in these embodiments, the system 100 may be configured to operate according to one or more of: the pressure asserted by the user on the equipment, the frequency and/or amplitude of the equipment vibration; the level of vibration transmitted from the equipment to the user's body, the proximity of a non-user, and the position of the equipment.

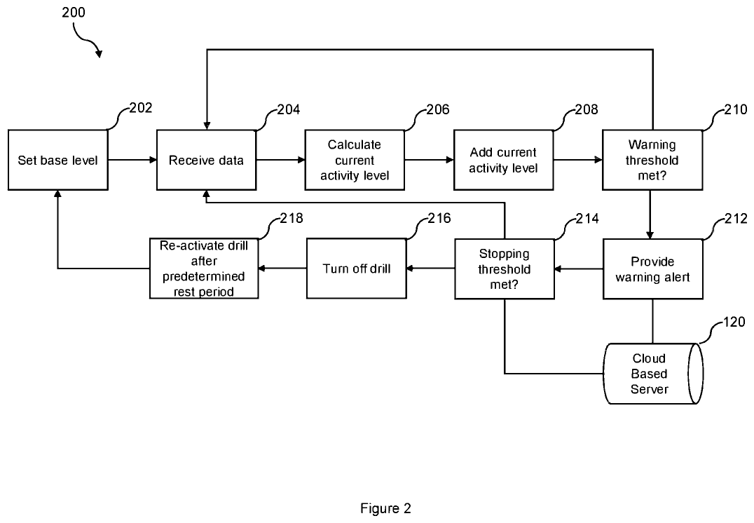

The processor 110 is operable to receive pressure data from the array of pressure sensors 140, receive frequency and/or amplitude data from the first vibrational sensor 160, receive vibrational data from the second vibrational sensor 162, receive proximity data from the proximity sensor 170, and receive position data from the position sensor 180. The processor 110 is also operable to process the received data with a method, to be discussed in more detail with reference to FIGS. 2 to 4, to obtain equipment usage data and provide feedback related to the equipment usage data. The alert device 150 may be operable to provide said feedback.

Turning now to FIG. 2, there is shown a method 200 for monitoring and mitigating user fatigue of an equipment, such as a pneumatic drill, using the equipment usage monitoring system 100. In particular, the system 100 for this method includes the array of pressure sensors 140, the alert device 150, the first vibrational sensor 160, and the second vibrational sensor 162. The skilled person will appreciate that the system 100 may comprise further components.

As the user's muscles become fatigued from using the drill, a risk of accident and/or injury increases. To combat the risk of excessive fatigue, physical rest periods should occur at prescribed intervals. It is an object of the method 200 to monitor the amount of time the drill is in use and provide a warning to the user when a rest is required.

In a first step 202 of the method 200, an accumulated activity level is set to a base level, the base level being indicative of there being no recent activity carried out with the equipment by the user. The base level may be set following a predetermined period of time elapsing since a previous usage session of the equipment.

At step 204, the processor 110 receives the pressure data from the array of pressure sensors 140, the frequency and/or amplitude data from the first vibrational sensor 160, and the vibrational data from the second vibrational sensor 162. The optimal interval between rest periods determined by this method 200 is influenced by the frequency and amplitude of vibration of the drill. Additionally, the optimal interval is influenced by a grip pressure applied to the drill by the user, as the grip pressure influences an amount of vibration transmitted to joints on the user's body. In particular, a temporal change in grip pressure is used to determine the optimal interval such that the strength and stamina of the user influences the frequency of rest periods.

At step 206, the processor 110 calculates a current activity level based on the pressure data, the frequency and/or amplitude data, and the vibrational data. A higher frequency and/or amplitude of the drill measured by the first vibrational sensor 160 may correspond to a higher current activity level. Furthermore, a significant temporal change in grip pressure may be indicative of a higher current activity level than a less significant temporal change in grip pressure. The frequency and/or amplitude of the drill, the pressure applied by the user in use, and the vibration level of the drill are all factors in determining the activity level. Each of the factors may be associated with a rating and/or weighting dependent on a value or response associated with the factors. The rating and/or rating may influence a degree by which each factor influences the determination of the overall activity level.

At step 208, the processor 110 adds the current activity level to the accumulated activity level.

At step 210, the processor 110 determines that the accumulated activity level meets or achieves a warning threshold. The warning threshold may be predetermined in line with regulations and/or local recommendations. The user may adapt these settings according to their needs, and different settings may be used depending on the user's attributes, for example the user's age or existing ailments or medical conditions. Alternatively or additionally, data correlation may be used to build a dynamic picture of the suitable usage periods for each user. The processor 110 also stores this warning threshold being met on the cloud-based server 120. For example, the passing of the warning threshold may be stored as data indicative of an activity level and/or a usage time associated with the current usage of the drill. This data may be used to further refine the warning threshold for the user, or further users.

If the processor determines that the accumulated activity level does not meet the warning threshold, steps 204 to 210 are repeated.

At step 212, the processor 110 causes the alert device 150 to provide a warning alert to the user. For example, in the case of the alert device 150 being safety goggles configured to provide a visual alert to the user, the goggles may display an amber warning, indicative of a medium risk.

At step 214, the processor 110 determines that the accumulated activity level meets or achieves a stopping threshold. The stopping threshold may be predetermined in line with regulations and/or local recommendations. The user may adapt these settings according to their needs, and different settings may be used depending on the user's attributes, for example the user's age or existing ailments. Alternatively or additionally, data correlation may be used to build a dynamic picture of the suitable usage periods for each user. The processor 110 also stores this stopping threshold being met on the cloud-based server 120. For example, the passing of the stopping threshold may be stored as data indicative of an activity level and/or a usage time associated with the current usage of the drill. This data may be used to further refine the stopping threshold for the user, or further users.

If the processor determines that the accumulated activity level does not meet the stopping threshold, steps 204 to 214 are repeated.

At step 216, the processor 110 causes the drill to turn off. In particular, the processor 110 communicates a stop signal to the drill such that the drill ceases to operate in response to receipt of the stop signal. Accordingly, once the stopping threshold has been met, the processor 110 causes the drill to turn off, thereby mitigating a risk of injury present from over-usage of the drill.

At step 218, the processor 110 transmits a re-activation signal to the drill after a predetermined rest period has elapsed. The rest period may be predetermined in line with regulations and/or local recommendations. The user may adapt these settings according to their needs, and different settings may be used depending on the user's attributes, for example the user's age or existing ailments or medical conditions. Alternatively or additionally, data correlation may be used to build a dynamic picture of the suitable rest periods for each user. For example, if in a subsequent usage session the user's temporal change in grip pressure is more significant than the temporal change in grip pressure of a preceding usage session, this may be indicative of a requirement for a greater rest period such that the temporal change is consistent across multiple usage sessions. The drill is inoperable by the user during this rest period. The processor 110 may be adapted to differentiate between users, for example via a sensor-enabled identification badge. Accordingly, the drill may be operated by a different user during the current user's rest period.

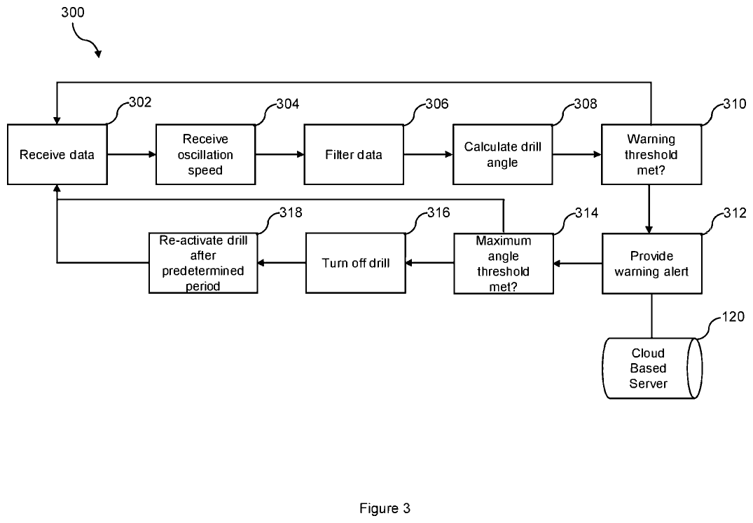

Turning now to FIG. 3, there is shown a method 300 a method for monitoring and mitigating positioning of an equipment, such as the pneumatic drill, using the equipment usage monitoring system 100. In particular, the system 100 for this method includes the alert device 150, and the position sensor 180, for example a micro electro mechanical system (MEMS) accelerometer 180. The skilled person will appreciate that the system 100 may comprise further components.

In the case of a pneumatic drill being used on a horizontal surface (for example a concrete surface), the drill should not be perpendicular to the horizontal surface and should instead be tilted at a slight angle from the perpendicular axis. The drill bit of the pneumatic drill should also be pointed away from the user, such that a handle of the drill is closer to the user than the drill bit to the user. It is an object of the method 300 to monitor and mitigate any danger that may be present as a result of the usage angle of the drill.

In a first step 302 of the method 300, the processor 110 receives accelerometer data from the MEMS accelerometer 180. In particular, the MEMS accelerometer 180 provides an acceleration signal comprising a gravitational component and a vibrational component. The gravitational component is representative of a gravitational acceleration. The vibrational component is representative of an acceleration caused by the vibration of the drill in use.

At step 304, the processor 110 receives a head oscillation speed from the drill. For example, the processor 110 may receive the head oscillation speed from a motor module of the drill. The head oscillation speed corresponds to a vibrational frequency of the drill and as such also corresponds to the vibrational component of the accelerometer data.

At step 306, the processor 110 removes the vibrational component from the accelerometer data. Additionally, the processor 110 applies a low-pass noise filter to the accelerometer data.

At step 308, the processor 110 calculates an angle of the drill based on the filtered accelerometer data. In particular, the filtered accelerometer data is projected onto three orthogonal axes, the projected signal being representative of an angle of the drill with respect to the Earth's gravitational field (i.e. the axis perpendicular to the horizontal surface on which the drill is being used). In the present example, the accelerometer 180 is aligned with the drill, for example an axis of the accelerometer 180 may be in alignment with the vertical length of the drill. In such a scenario, when the drill is in a stationary and vertical position relative to the surface of the Earth, the force of gravity is entirely on the accelerometer axis, and the other axes will have no force component. The skilled person will appreciate that there may be some drift and noise to account for. This drift and noise may be accounted for by a calibration step where the user places the equipment in a stand that is known to be vertical, such that there are no force components along the other axes, and the accelerometer readings are recorded and used to calibrate the estimated angle of orientation.

At step 310, the processor 110 determines that the angle of the drill exceeds a warning angle threshold. The warning angle threshold may be predetermined in line with industry regulations and/or industry recommendations. The user may adapt these settings according to their needs, and different settings may be used depending on the user's attributes, for example the user's age or existing ailments. Alternatively or additionally, data correlation may be used to build a dynamic picture of the suitable usage angle for each user.

At step 312, the processor 110 causes the alert device 150 to provide a warning alert to the user. For example, in the case of the alert device 150 being safety goggles configured to provide a visual alert to the user, the goggles may display an amber warning, indicative of a medium risk.

At step 314, the processor determines that angle of the drill exceeds a maximum angle threshold. The maximum angle threshold may be predetermined in line with industry regulations and/or industry recommendations. The user may adapt these settings according to their needs, and different settings may be used depending on the user's attributes, for example the user's age or existing ailments. Alternatively or additionally, data correlation may be used to build a dynamic picture of the suitable maximum angle for each user.

At step 316, the processor 110 causes the drill to turn off. In particular, the processor 110 communicates a stop signal to the drill such that the drill ceases to operate in response to receipt of the stop signal. Accordingly, once the maximum angle threshold has been met, the processor 110 causes the drill to turn off, thereby mitigating a risk of injury present from the user using the drill at an inappropriate, or if the user drops the drill.

At step 318, the processor 110 transmits a re-activation signal to the drill after a predetermined period has elapsed.

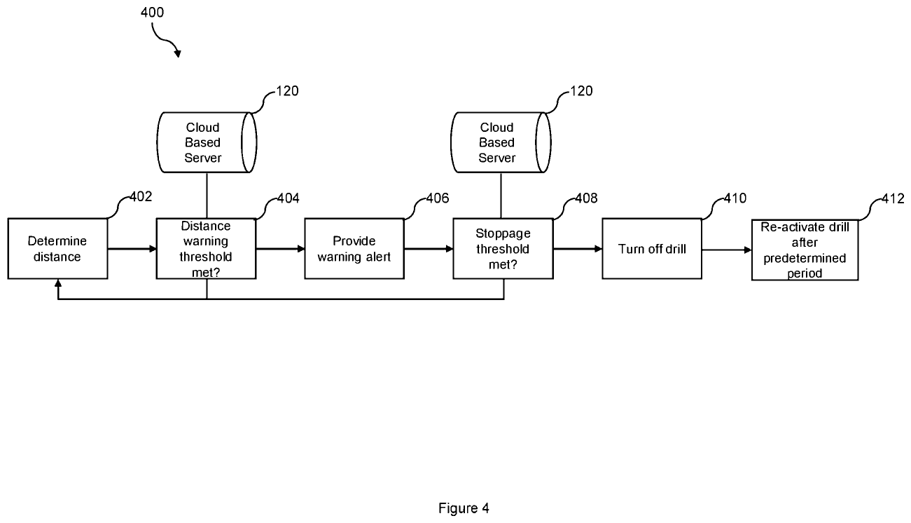

FIG. 4 is a method 400 for monitoring and mitigating proximity of an equipment, such as the pneumatic drill, using the equipment usage monitoring system 100. In particular, the system 100 for this method includes the alert device 100, and the proximity sensor 170. In the present example, the proximity sensor 170 is a wireless sensing system 170 configured to detect proximity data indicative of a distance between the drill and a non-user's device. The wireless sensing system 170 utilises Bluetooth Low Energy. The non-user's device is a sensor-enabled identification badge in the present example.

Equipment such as the pneumatic drill of the present example should not be used in close proximity to other people (i.e. non-users of the equipment). There is a risk that the drill slips from a hand of the user, which may subsequently lead to the injury of another person. It is an object of the method 400 to monitor and mitigate danger that may be present when a non-user is in proximity to the drill whilst the drill is in use.

In a first step 402 of the method 400, the processor 110 determines a distance between the drill and a non-user. In particular, the processor 110 determines a distance between the drill and a sensor-enabled identification badge associated with the non-user. The sensor-enabled identification badge transmits a Bluetooth Low Energy signal. The processor determines the distance based on a received signal strength of the signal. For example, the processor may compare the received signal strength to a signal strength index which provides an estimate of the distance based on the received signal strength.

At step 404, the processor 110 determines that the distance meets or achieves a distance warning threshold. The warning threshold may be predetermined in line with regulations and/or local recommendations. The user may adapt these settings according to their needs, and different settings may be used depending on the user's attributes, for example the user's age or existing ailments or medical conditions. Alternatively or additionally, data correlation may be used to build a dynamic picture of the suitable distance for each user. The processor 110 also stores this warning threshold being met on the cloud-based server 120. For example, the passing of the warning threshold may be stored as data indicative of a non-user being in proximity to the drill. This data may be used to further refine the warning threshold for the user, or further users.

At step 406, the processor 110 causes the alert device 150 to provide a warning alert to the user. For example, in the case of the alert device 150 being safety goggles configured to provide a visual alert to the user, the goggles may display an amber warning, indicative of a medium risk.

At step 408, the processor 110 determines that the distance meets or achieves a stopping threshold. The stopping threshold may be predetermined in line with regulations and/or local recommendations. The user may adapt these settings according to their needs, and different settings may be used depending on the user's attributes, for example the user's age or existing ailments. Alternatively or additionally, data correlation may be used to build a dynamic picture of the suitable usage periods for each user. The processor 110 also stores this stopping threshold being met on the cloud-based server 120. For example, the passing of the stopping threshold may be stored as data indicative of a non-user being in proximity to the drill. This data may be used to further refine the stopping threshold for the user, or further users.

At step 410, the processor 110 causes the drill to turn off. In particular, the processor 110 communicates a stop signal to the drill such that the drill ceases to operate in response to receipt of the stop signal. Accordingly, once the stopping threshold has been met, the processor 110 causes the drill to turn off, thereby mitigating a risk of injury present to the non-user approaching the drill.

At step 412, the processor 110 transmits a re-activation signal to the drill after a predetermined stop period has elapsed. The stop period may be predetermined in line with regulations and/or local recommendations. The user may adapt these settings according to their needs, and different settings may be used depending on the user's attributes, for example the user's age or existing ailments. Alternatively or additionally, data correlation may be used to build a dynamic picture of the suitable stop periods for each user. The drill is inoperable during this rest period.

Alternatively, the processor 110 may be adapted to transmit the re-activation signal following a determination that the non-user is located at a safe distance, such that the stop threshold is no longer met. Accordingly, the drill may be operated once the non-user is at the safe distance.

The skilled person will appreciate that whilst the methods 200, 300, 400 have been described separately, they may each be implemented by the system 100 in unison, such that the system 100 provides a composite system for monitoring and mitigating usage of an equipment.

Furthermore, the skilled person will appreciate that the equipment may be any equipment having an associated risk of use, for example an angle grinder, a chainsaw, or a power hose.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An equipment usage monitoring system for use with an equipment, the system comprising:
a processor in communication with:
the equipment;
an equipment sensor operable to provide equipment data associated with the equipment; and
an alert member operable to provide an alert to a user of the equipment;
wherein the processor is operable to:
receive the equipment data from the equipment sensor;
determine that the equipment data achieves a warning threshold;
cause the alert member to provide an alert to the user in response to the warning threshold being met;
determine that the equipment data achieves a stoppage threshold; and
transmit a stoppage signal to the equipment in response to the stoppage threshold being met, the stoppage signal causing the equipment to turn off.

2. The system of claim 1, wherein the equipment sensor is one or more selected from the range of:
a pressure sensor arranged to detect a pressure applied to the equipment; and
a vibration sensor arranged to detect vibrational data of the equipment.

3. The system of claim 1, further comprising a user sensor in communication with the processor, the user sensor configured to provide user data associated with the user.

4. The system of claim 3, wherein the user sensor is a vibration sensor arranged to detect vibrational data of the user.

5. The system of claim 1, wherein the warning threshold is an activity level warning threshold and the stoppage threshold is an activity level stoppage threshold.

6. The system of claim 5, wherein the activity level threshold is predetermined based on a correlation.

7. The system of claim 5, wherein the threshold is additionally one or more selected from the range of:
a pressure threshold; and
a temporal threshold.

8. The system of claim 7, wherein the temporal threshold is adjustable based on the equipment data and the user data.

9. The system of claim 1, wherein the equipment sensor is an angular position sensor.

10. The system of claim 9, wherein the angular position sensor is an accelerometer.

11. The system of claim 9, wherein the warning threshold is an angular warning threshold and the stoppage threshold is an angular stoppage threshold.

12. The system of claim 1, wherein the equipment sensor is a proximity sensor.

13. The system of claim 12, wherein the proximity sensor is a proximity sensing system configured to determine a distance between the equipment and a non-user.

14. The system of claim 12, wherein the warning threshold is a proximity warning threshold and the stoppage threshold is a proximity stoppage threshold.

15. The system of claim 1, wherein the processor stores, on a data store, an instance of the warning threshold and/or the stoppage threshold being met.

16. The system of claim 1, wherein the equipment is a pneumatic drill.

17. An equipment usage monitoring method for use with an equipment, the method comprising:
receiving, at a processor from an equipment sensor, equipment data;
determining, by the processor, that the equipment data achieves a warning threshold;
causing, by the processor, an alert member to provide an alert to a user of the equipment, in response to the warning threshold being met;
determining, by the processor, that the equipment data achieves a stoppage threshold; and
transmitting, by the processor, a stoppage signal to the equipment in response to the stoppage threshold being met, the stoppage signal causing the equipment to turn off.

18. The method of claim 17, wherein the equipment sensor is one or more selected from the range of:
a pressure sensor arranged to detect a pressure applied to the equipment; and
a vibration sensor arranged to detect vibrational data of the equipment; and
wherein the threshold is one or more selected from the range of:
an activity threshold;
a pressure threshold; and
a temporal threshold.

19. The method of claim 17, wherein the equipment sensor is an angular position sensor, the warning threshold is an angular warning threshold, and the stoppage threshold is an angular stoppage threshold.

20. The method of claim 17, wherein the equipment sensor is a proximity sensor, the warning threshold is a proximity warning threshold, and the stoppage threshold is a proximity stoppage threshold.
